(19) United States
(12) Patent Application Publication
(10) Pub. No.: US 2026/0249115 A1
(43) Pub. Date: Aug. 27, 2026

(54) FLAME MITIGATION DEVICE FOR FUEL CONTAINER

(71) Applicant: SCEPTER US HOLDING COMPANY, Akron, OH (US)

(72) Inventors: Daniel MARSHALL, Hudson, OH (US); Sergio GARZA, Bella Vista, AZ (US)

(21) Appl. No.: 18/727,468

(22) PCT Filed: Jan. 25, 2023
(86) PCT No.: PCT/US2023/061289

§ 371 Date: Jul. 9, 2024

(51) Int. Cl. A62C 3/06; A62C 4/00

(52) U.S. Cl. CPC A62C 3/065; A62C 4/00

(57) ABSTRACT

Various embodiments described herein are related to a flame mitigation device that can comprise a rigid body comprising a side wall having a first perforation of a first size and a second perforation of a second size. The rigid body can be hollow and the first size can be greater than the second size Also, the first perforation and the second perforation can provide fluid communication through the side wall. Moreover, the flame mitigation device is configured to absorb enough heat to drop a burning air/fuel mixture below its auto-ignition temperature at a flame speed between 4 and 6 meters per second.

### CROSS-REFERENCE TO RELATED APPLICATIONS

This application claims the benefit of U.S. Provisional Patent Application No. 63/303,302 filed on Jan. 26, 2022, the contents of which are incorporated by reference herein in its entirety.

### BACKGROUND

The present disclosure relates to a flame mitigation device/ flame arrestors for portable containers, and fuel container assemblies incorporating the same. The flame mitigation devices have particular application with portable fuel containers and will be described with particular reference thereto. However, it is to be appreciated that the present exemplary embodiments are also amenable to other like applications.

Consumer portable fuel containers (CPFCs) are well known in the art. They are used to transport, store and dispense diesel fuel and gasoline. Consumers utilize the CPFCs in connection with a fuel tank typically associated with an internal combustion engine such as a lawnmower, chain saw, snowmobile, power generator or the like. As used herein, the term, portable fuel container refers to a container that can be carried by the consumer. Such portable fuel containers have traditionally been constructed of metal or synthetic resin.

A flame mitigation device (“FMD”) is a safety device intended to reduce the chance of some types of fires and explosions within portable fuel storage containers, among other things. In theory, an FMD functions by absorbing the heat from a flame front traveling at subsonic velocities, thus dropping the burning gas/air mixture below its auto-ignition temperature; consequently, the flame cannot survive. FMDs can reduce the chances the flashback explosions which occur when vapor escaping the container contacts a flame or a spark. The vapor can ignite and “flash back” inside the container.

Current FMDs for use with synthetic resin portable fuel containers include a plurality of small holes/openings/perforations each of substantially uniform size. Generally, the perforations are sized to present an open area of not more than about 0.04 inches (1.0 mm) by 0.04 inches (1.0 mm). The flow of fluid therethrough is dependent on both the number of perforations and size of those perforations. Consumers desire durable flame arrestors that are effective in suppressing flames while presenting no obstacles in their implementation and use. The present disclosure provides certain improvements to FMDs.

### SUMMARY OF DISCLOSURE

Various details of the present disclosure are hereinafter summarized to provide a basic understanding. This summary is not an extensive overview of the disclosure and is neither intended to identify certain elements of the disclosure, nor to delineate the scope thereof. Rather, the primary purpose of this summary is to present some concepts of the disclosure in a simplified form prior to the more detailed description that is presented hereinafter.

In accordance with one or more aspects of the present disclosure, a flame mitigation device is described. The flame mitigation device can comprise a rigid body comprising a side wall having a first perforation of a first size and a second perforation of a second size. The rigid body can be hollow and the first size can be greater than the second size Also, the first perforation and the second perforation can provide fluid communication through the side wall. Moreover, the flame mitigation device is configured to absorb enough heat to drop a burning air/fuel mixture below its auto-ignition temperature at a flame speed between 4 and 6 meters per second.

In accordance with one or more aspects of the present disclosure, a further flame mitigation device is described. The flame mitigation device can comprise a rigid body configured to be seated within a nozzle of a fuel container. The flame mitigation device can also comprise a first perforation that defines a first hole extending through a side wall of the rigid body. Further, the flame mitigation device can comprise a second perforation that defines a second hole extending through the side wall. The first hole can have first cross-area that is greater than a second cross-area of the second hole.

In accordance with one or more aspects of the present disclosure, a further flame mitigation device is described. The flame mitigation device can comprise a hollow rigid body comprising an opening and a side wall. The opening is positioned at a first end of the hollow rigid body. Further, the side wall extends from the opening to a second end of the hollow rigid body. The flame mitigation device can also comprise a first perforation in the side wall, and a second perforation in the side wall. The first perforation can have a size that is greater than the second perforation.

### BRIEF DESCRIPTION OF THE DRAWINGS

The following figures are included to illustrate certain aspects of the embodiments, and should not be viewed as exclusive embodiments. The subject matter disclosed is capable of considerable modifications, alterations, combinations, and equivalents in form and function, as will occur to those skilled in the art and having the benefit of this disclosure.

FIG. 1 is cross-sectional illustration of an example fuel container with an FMD in accordance with one or more embodiments described herein.

FIG. 2 is an illustration of an example FMD in accordance with one or more embodiments described herein.

FIG. 3 is an illustration of an example FMD in accordance with one or more embodiments described herein.

FIG. 4A is an illustration of an example arrangement of perforations in accordance with one or more embodiments described herein.

FIG. 4B is an illustration of another example arrangement of perforations in accordance with one or more embodiments described herein.

FIG. 4C is an illustration of another example arrangement of perforations in accordance with one or more embodiments described herein.

### DETAILED DESCRIPTION

A more complete understanding of the components, processes and apparatuses disclosed herein can be obtained by reference to the accompanying drawings. These figures are merely schematic representations based on convenience and the ease of demonstrating the present disclosure and are therefore not intended to indicate relative size and dimensions of the devices or components thereof and/or to define or limit the scope of the exemplary embodiments.

Although specific terms are used in the following description for the sake of clarity, these terms are intended to refer only to the particular structure of the embodiments selected for illustration in the drawings and are not intended to define or limit the scope of the disclosure. In the drawings and the following description below, it is to be understood that like numeric designations refer to components of like function.

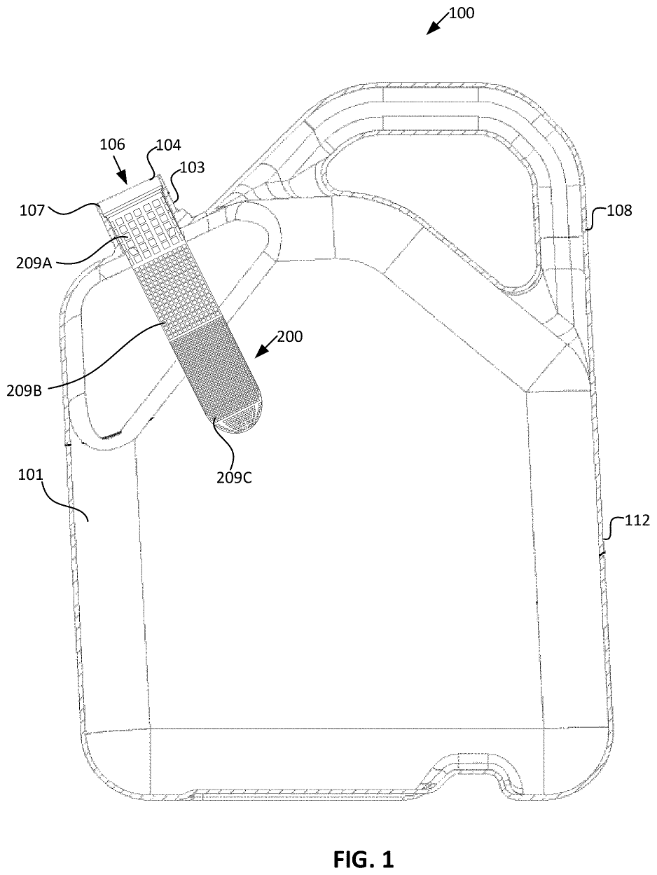

The present disclosure relates, generally to an FMD employing perforations of at least two different sizes that contribute to at least one of flame mitigation and/or fluid flow properties of the FMD. Referring now to FIG. 1, shown is an illustration of an exemplary fuel reservoir such as container 100, which may be referenced throughout this disclosure. The container 100 may be suited for use with a flame mitigation device (“FMD”) 200 according to an embodiment of the disclosure. With regard to FIG. 1, those skilled in the art will recognize that the portable fuel container 100 is shown as an example of the variety of different fuel containers with which the FMD 200 may be employed. The present disclosure is not limited to use with or as part of the particular fuel container 100 as shown herein.

The fuel container 100 includes a wall 112 that forms a hollow tank body 101, and a neck 103 (fill port). The neck 103 may include a threaded outer surface 105 used to secure various attachments e.g., nozzle, thereto. The wall 112 can be any shape or dimension for receiving liquids, for example hydrocarbon-based fuels, within the hollow tank body 101. The wall 112 is made from a variety of polymers that can be shaped, for example by injection molding and/or blow molding techniques. Preferably, the polymers of the wall 112 do not degrade in the presence of volatile liquids, such as hydrocarbon-based fuels. For example and without limitation, nylon and polyethylene are suitable polymers for the construction of the fuel container 100. The hollow tank body 101 can be molded of synthetic resin (e.g., polyethylene). The finish of the synthetic resin surface can be specifically selected for minimizing a climbing effect of fuel moving across it.

The wall 112 also defines the neck 103 that provides fluid communication between the hollow tank body 101 and outside the container 100. The neck 103 includes sidewalls that are formed by extensions of the external surface of the wall 112. Alternatively, the neck 103 may comprise a hole in the wall 112 and an annular flange that is secured about the hole. The flange extends away from the external surface of the wall 112 to provide sidewalls of the neck 103. The sidewalls of the neck 103, provide a surface for removably connecting an accessory such as a fill port cap and/or spout. For example, such an accessory can sealably connect by friction fit, snap fit, a threaded connection (via threads 105) with an internal or external surface of the neck 103 sidewalls.

As illustrated in the exemplary embodiment of FIG. 1, the neck 103 is spaced forwardly of a handle 108 that facilitates transport of the container 100. The neck 103 presents a substantially round opening 106 allowing fluid to ingress and egress from the hollow tank body 101. The neck 103 is preferably cylindrical and presents a threaded outer surface 105 and an inner surface. In use, a dispensing spout may cover the neck 103. The neck 103 is used for both filling and dispensing the fuel into, and out of, the fluid container 100. Those skilled in the art will recognize that the filling and dispensing locations on the container 100 may differ, being at separate locations on the container 100. A dispensing spout is generally attached via threads to the neck 103. Once attached, the spout is in fluid communication with the hollow tank body 101.

When the dispensing spout is removed, as shown in FIG. 1, a hole or opening 106 is exposed. The opening 106 permits filling the hollow tank body 101 with fuel (or other fluids). When the spout is removed, fuel may also be poured from the hollow tank body 101. The size of the opening 106 can be at least at least 2 square inches (50.3 mm²) but is typically not more than 10 square inches (254 mm²). The container 100 may also include a vent (not illustrated) for periodically venting the container 100 to atmosphere.

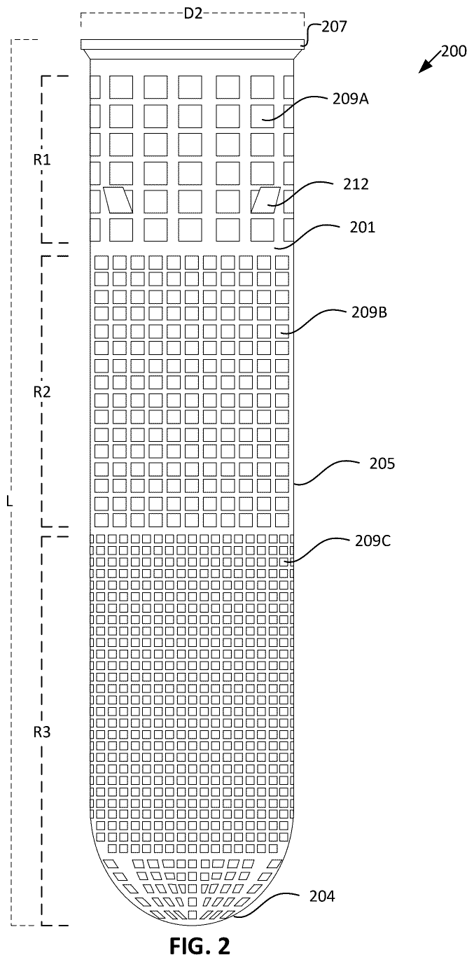

With reference to FIGS. 1 and 2, the container 100 also includes a flame mitigation device (FMD) 200. The exemplary FMD 200 is used to mitigate spark and/or flame entering the interior of the hollow tank body 101. The FMD 200 is generally sized and shaped, i.e., “configured” so to be capable of being inserted into the neck 103 of a portable fuel container 100. The FMD 200 generally operates by absorbing enough heat to drop the burning air/fuel mixture below its auto-ignition temperature at a flame speed between 4-6 meters per second.

The FMD 200 includes a device body 201 of length L having both an inner sidewall (not illustrated) and outer sidewall 205, the general shape of which can be either cylindrical, semi-cylindrical, conical, cuboid, or the like. The inner sidewall can face towards a central longitudinal axis of the device body 201, while the outer sidewall 205 can face in an opposite direction (e.g., away from a central longitudinal axis of the device body 201). Those skilled in the art will recognize that triangular, square and multi-angle shapes such as hexagonal or octagonal are also possible. The device body 201 is configured with a plurality of perforations 209 that allow fluid communication from the inner sidewall to the outer sidewall 205. That is, fluid flow is possible through the FMD 200 through the perforations 209.

The FMD 200 may be made of any suitable material that does not degrade in the presence of volatile liquids, such as hydrocarbon-based fuels including but not limited to nylon, polyester, polyethylene, polypropylene or other synthetic resins compatible with the material the container body and resistant to chemicals. The material of the FMD 200 may also be resistant to flames. In some embodiments, the FMD 200 is composed of a substantially rigid polymer material. The composition is such that the FMD 200 is able to hold its own shape. Per ASTM-F3326, the material of the FMD 200 (e.g., the material of the device body 201) is similar to the material of the hollow tank body 101 and passes all material testing requirements in accordance with ASTM-F852.

In some embodiments and as illustrated in the example embodiments of FIGS. 1-2, a generally annular flange 207 can extends circumferentially around a first end of the FMD 200. Those skilled in the art will recognize that the shape of the annular flange 207 is not limiting and other shapes of the flange 207 are also within envisaged herewith. In some embodiments, the annular flange 207 holds the FMD 200 at predetermined position within the neck 103 of a portable fuel container 100. In one or more embodiments, the annular flange 207 can define an opening in the device body 201 that is in fluid communication with a cavity defined by the device body 201 (e.g., where the cavity is positioned along the central longitudinal axis of the device body 201, and the annular flange 207 is positioned at least partially surrounding the central longitudinal axis of the device body 201). As shown in FIG. 1, the annular flange 207 can project outwardly from the outer sidewall 205 a sufficient distance to engage an inner surface 107 of the neck 103 of the portable fuel container into which it is to be received such that the FMD 200 is prevented from falling into the interior of the hollow tank body 101.

In some embodiments, the flange 207 is configured to abut the outer edge 104 of the neck 103 about the opening 106. This abutment allows the device body 201 to be inserted into the opening 106 of the neck 103 and prevent the FMD 200 from advancing through the neck 103 (e.g., falling into the container 100). In other embodiments, the flange 207 is configured to engage an inner surface 107 of the neck 103 and prevent the FMD 200 from falling into the container 100. In some embodiments, the inner surface 107 of the neck 103 has a decreasing inner dimension, e.g., diameter, (from the outer edge 104 toward the hollow tank body 101). In these embodiments, the flange 207 abuts the inner surface 107 at a point which the inner diameter of neck 103 matches the outer diameter of the flange 207. In yet still other embodiments, the flange 207 is configured to engage an interior surface feature of the interior surface 107 of the neck 103. For example, the interior surface 107 of the neck 103 may include a ledge configured to abut the flange 207 of the FMD 200.

As described above, the device body 201 is “perforated” and can include numerous perforations 209 defining one or more holes in the inner sidewall and/or outer sidewall 205. The perforations 209 can have any shape. In the illustrated embodiments, the perforations 209 have a polygonal shape (e.g. a rectangular-shape). The shape may be optimized in order to increase/maximize the fractional portion or percentage of the inner sidewall and/or outer sidewall 205 that can be made open and allow fluid to pass through the FMD 200 and into, as well as out of, the container 100.

The plurality of perforations 209 in the device body 201 can provide a mesh and/or porous surface that permits the passage of fluids through the neck 103 and/or the device body 201 to fill, or empty, the container 100. As used herein, “perforation open area” means the minimum cross-sectional area of a hole defined by a perforation 209, measured normal to the direction of extension of the perforation 209 through the inner sidewall and outer sidewall 205 of the device body 201. The FMD 200 operates by absorbing enough heat to drop the burning air/fuel mixture below the auto-ignition temperature at a flame speed between 4-6 meters per second. The perforations 209 in the device body 201 can define a total open area (e.g., a summation of perforation open areas) sufficient to permit normal filling of the container 100 at a moderate rate of flow without build-up and overflow of fuel from the container 100. For example the total open area of the perforations 209 in the FMD 200 permit at least nine (9) gallons per minute of gasoline to flow therethrough under common gasoline filling conditions (e.g., atmospheric pressure and room temperature).

The FMD 200 includes perforations 209 of at least two different sizes (e.g., one or more first perforations 209A can be sized differently, and/or shaped differently, from one or more second perforations 209B and/or third perforations 209C). By different sizes it is meant that each hole in the inner sidewall and outer sidewall 205 defined by respective first perforations 209A has an open area that is different than that of each hole in the inner sidewall and outer sidewall 205 defined by respective second perforations 209B and/or third perforations 209C. In various embodiments, the FMD 200 can comprise multiple sets of perforations 209, with each set comprising perforations 209 of a respective size or shape. For example, FIG. 2 depicts an example FMD 200 that includes at least three sets of perforations 209 (e.g., a first set comprising the one or more first perforations 209A, a second set comprising the one or more second perforations 209B, and/or a third set comprising the one or more third perforations 209C), where each set can be associated with perforations 209 of a respective size and/or shape. For example, one or more first perforations 209A can be larger than one or more second perforations 209B, which in turn can be larger than one or more third perforations 209C.

For instance, a first hole in the inner sidewall and outer sidewall 205 defined by a respective first perforation 209A can have a larger open area than a second hole in the inner sidewall and outer sidewall 205 defined by a respective second perforation 209B. Further, the second hole in the inner sidewall and outer sidewall 205 defined by the respective second perforation 209B can have a larger open area than a third hole in the inner sidewall and outer sidewall 205 defined by a respective third perforation 209C.

Additionally, in various embodiments the sets of perforations 209 can be oriented in one or more patterned arrangements. For example, FIG. 2 illustrates perforations 209 in a stacking arrangement, the FMD 200 may include greater than three sets of perforations 209, each with a respective size and/or shape. For example and without limitation the FMD 200 may include perforations 209 of two different sizes, three different sizes, four different sizes, five different sizes, six different sizes, etc.

In some embodiments, the perforations present in the device body 201 have an increasing perforation open area along the length L from the flange 207 toward the opposite end 204 of the device body 201. In other embodiments, the perforations 209 present in the device body 201 can have a decreasing perforation open area along the length L from the flange 207 toward the end 204. In yet still other embodiments, the perforations 209 present in the device body 201 may have a portion of length L with increasing perforation open area followed by another portion of length L with decreasing perforation open area.

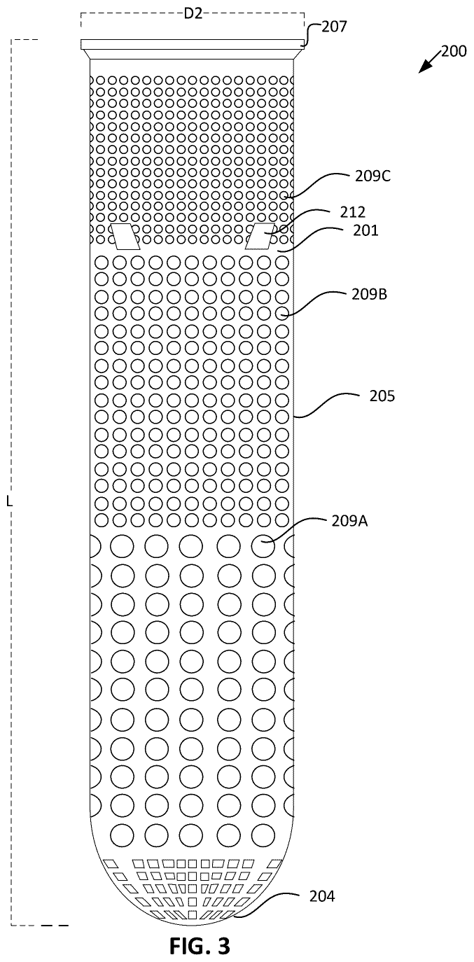

As shown in FIG. 3, in some embodiments, the perforations 209 can be smaller near the flange 207 of the FMD 200 than the opposite end 204, where heat dissipation is more desirable as the flame propagates from the opening 106 of the neck 103 down through the FMD 200. The smaller the perforation open area of the perforations 209 at the beginning of the flame path may quench the flame faster, where having perforations 209 with a perforation open area that is larger near the opposite end 208 can assist the flow of fluid into the container 100 (e.g., can mitigate backsplash of fluid being poured into the container 100). Further, FIG. 3 exemplifies that the perforations 209 can have a circular shape or a polygonal shape (e.g., a rectangular shape).

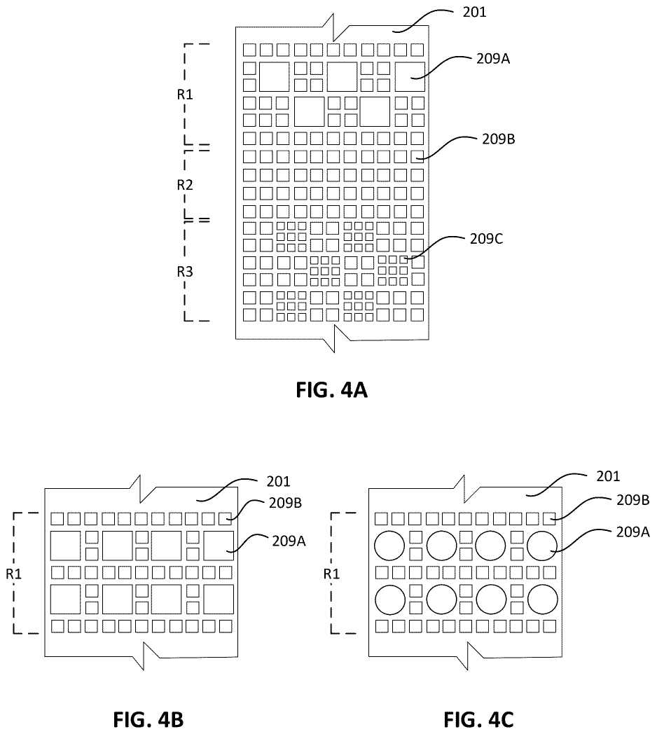

In some embodiments, the FMD 200 includes an arrangement of perforations 209 (e.g., a combination of first perforations 209A, second perforations 209B, and/or third perforations 209C arranged in a pattern formation). FIGS. 4A-C illustrate example perforation arrangements that can be embodied by the first perforations 209A, second perforations 209B, and/or third perforations 209C across the device body 201. As described herein, the perforation arrangements are not limited to perforations 209 of two or three sizes; rather embodiments comprising perforations 209 of four or more sizes are also envisaged. In one or more embodiments, the perforation arrangement can include patterns of perforations 209 of varying sizes extending through the device body 201 and distributed along the length L of the device body 201 (e.g., along the entire length L or a portion of the length L). It is to be understood that while rectangular/square perforations 209 are illustrated, the shape of the perforations 209 is not limited to a rectangular shapes or a single shape. For example, the FMD 200 may employ square perforations (illustrated) and circle-shape perforations. For instance, in one or more embodiments, the one or more first perforations 209A can have a rectangular shape, while the one or more second perforations 209B can have a circular shape. In some embodiments, perforations 209 of a common set can have different shapes while exhibiting an equivalent, or substantially equivalent, perforation open area.

Furthermore, it is to be appreciated that the illustrated embodiments of FIGS. 4A-C are exemplary and that other arrangements and patterns of perforations of multiple sizes may be employed in an FMD 200 without departing from the scope of this disclosure.

Generally, perforations 209 according to the present disclosure have a perforation open area between about 0.5 mm² to about 10.0 mm², including 1.0 mm² to about 9.0 mm², 1.0 mm² to about 8.0 mm², 1.0 mm² to about 7.0 mm², 1.0 mm² to about 6.0 mm² and 1.0 mm² to about 5.0 mm². In some embodiments, the perforations have a largest dimensions between 1.0 mm² and 4.0 mm². In yet still further embodiments, the perforations 209 have a largest dimensions between 1.0 mm² and 2.4 mm². For example and without limitation, an FMD 200 having various sized perforations 209 may have one or more first perforations 209A with a perforation open area of about 2.4 mm² and one or more second perforations 209B with a perforation open area of about 1.0 mm². For instance, the perforations 209 can have a square shape having a perforation open area that is greater than or equal to 0.04 inches×0.04 inches and less than or equal to 0.08 inches×0.08 inches. In another instance, the perforations 209 can have a diameter of at least 0.04 inches.

As shown in FIG. 2, the device body 201 can be characterized by a plurality of regions R (e.g., a first region R1 and one or more other regions, such as a second region R2 and/or a third region R3). For example, each region R can extend along a portion of the length L of the device body 201 and around a circumference of the device body 201. In one or more embodiments, the regions R can be defined based on the size of the perforations 209 comprised within the region R. For instance, FIG. 2 depicts an example embodiment in which the first perforations 209A are located exclusively within the first region R1, the second perforations 209B are located exclusively within the second region R2, and the third perforations 209C are located exclusively within the third region R3.

Alternatively, in one or more embodiments, each region R can be defined based on the perforation arrangement comprised within the region R. For example, multiple perforation arrangements can be dispersed across the device body 201. For example, FIG. 4A depicts an example segment of the device body 201 in which another example first region R1 can include one or more first perforations 209A and one or more second perforations 209B. For instance, within the example first region R1 shown in FIG. 4A, the first protrusions 209A can be arranged in rows, where the second protrusions 209B can be positioned between respective first protrusions 209A within each row. Additionally, the example second region R2 shown in FIG. 4A can be comprised of just second protrusions 209B. Further, within the example third region R3 shown in FIG. 4A, groups of third protrusions 209C can be arranged in rows, where the second protrusions 209B can be positioned between respective groups of third protrusions 209C within each row. Further, FIG. 4B illustrates another example perforation arrangement. As shown in FIG. 4C, the perforations 209 can exhibit a plurality of shapes in accordance with one or more embodiments described herein. For example, FIG. 4C depicts an example perforation arrangement comprising first perforations 209A having a circular shape and second perforations 209B having a polygonal shape (e.g., a rectangular shape).

In some embodiments, the FMD 200 includes at least one cantilevered retention member 212. For example, the device body 201 can have one or more cantilevered retention members 212 extending from the outer sidewall 205, where the cantilevered retention members 212 can be configured to prevent removal of the FMD 200 from within the portable fuel container 100. In some embodiments, the cantilevered retention members 212 are separated at 120-degree intervals along the outer sidewall 205 and about the perimeter of the FMD 200. Each cantilevered retention member 212 can include a cantilever or sloped surface extending from the outer sidewall 205 away from the central longitudinal axis of the FMD 200. However, it is to be appreciated that any spaced apart relation of retention members 212 may be employed without departing from the scope of this disclosure. The cantilevered retention members 212 can be positioned about 2.5 mm (1-inch) below the annular flange 207. In use, the retention members 212 each frictionally engage within the container 100, below the neck 103, and are used as a safety feature for preventing accidental removal of the FMD 200 from the interior of the fuel container 100.

In some embodiments and as illustrated in the example embodiment of FIG. 2, the FMD 200 includes a substantially dome-shaped end 204. Although the dome shaped bottom end 204 is illustrated as substantially spherical, those skilled in the art will recognize that it also may take the shape of a paraboloid of revolution or other shape. The unique shape of the bottom end 204 increases fuel flow. In other embodiments, the bottom end 204 is substantially flat. It is to be appreciated that the shape of the bottom end 204 is not limiting.

The FMD 200 is inserted into the neck 103 of the container 100, such that the FMD 200 is suspended in the interior volume of the hollow tank body 101 providing a flame mitigation property to the total container 100. In certain embodiments, it may be desirable for the FMD 200 be permanently attached (i.e., non-removable) to the container 100 by, for example, bonding or welding the FMD 200 to the neck 103. The attachment of the FMD 200 to the neck 103 of the container 100 is generally a sealed connection, meaning that all fluid exchange between the interior and exterior of the container 100 takes place through the FMD 200 (and the perforations 209).

In some embodiments, the FMD 200 is assembled and sealed to the inner surface 107 of the neck 103 of the container 100 by way of a frictional fit. Here, the inner surface 107 of the neck 103 may have a decreasing inner dimension (e.g. diameter) towards a central axis of the hollow tank body 101. In these embodiments, the flange 207 can abut the inner surface 107 at a point which the inner diameter of neck 103 matches the outer diameter D2 of the flange 207. The flange 207 and/or portions of the device body 208 can be bonded to the interior surface 107 of the neck 103. Bonding may include but is not limited to: welding, melting, heat staking, adhesively sealing, and/or a combination thereof.

In other embodiments, the flange 207 is configured to engage an inner surface feature of the neck 103. For example, the interior surface 107 of the neck 103 may include an annular ledge having a diameter less that the initial diameter of the opening 106, and less than the outer diameter of the flange 207. In this way, the flange 207 is prevented from falling into the hollow tank body 101 by abutment of the ledge on the inner surface 107 of the neck 103. The flange 207 and/or portions of the device body 201 may be bonded to the interior surface 107 of the neck 103 and ledge. Bonding may include but is not limited to: welding, melting, heat staking, adhesively sealing, and/or a combination thereof.

In some embodiments, the flange 207 is configured to abut and seal against the outer edge 104 of the neck 103. This abutment allows the device body 201 of the FMD 200 to insert into the opening 106 of the neck 103 and prevent the FMD 200 from advancing through the neck 103 (e.g., falling into the container 100). The flange 207 may be bonded to outer edge 104. Bonding can include but is not limited to: welding, melting, heat staking, adhesively sealing, and/or a combination thereof.

In some embodiments the FMD 200 is mechanically secured to the neck 103. Mechanical attachment may include but is not limited to use of fasteners, snap fit, press fit, and friction fit of the FMD 200 to some portion of the neck 103. In the example embodiment depicted in FIG. 1, the FMD 200 is mechanically secured to the neck 103 by way of the cantilevered retention members 212 as described briefly above and best understood with reference thereto. In use, the cantilevered retention members 212 each frictionally engage within the interior of the container 100 wall, below the neck 103, and are used as a safety feature for preventing accidental removal of the FMD 200 from the interior of the container 100. In some embodiments, each retention member 212 engages below the container outer edge wherein the sizing being complementary such that the retention members 212 are sufficiently resilient and preferably able to deflect upon engagement. In some embodiments, the inner surface 107 also includes an interior surface feature, similar in some aspects to ledge as discussed above. That is, the inner surface 107 of the neck 103 can include an annular interior surface feature configured to prevent the flange 207 (and therefore the FMD 200) from falling into the hollow tank body 101. In some embodiments, the interior surface feature provides a sealing engagement with the flange 207, such that fluid exchange between the interior volume of the hollow tank body 101 and exterior environment, only occurs through the FMD 200 (and through the perforations 209). In some further embodiments, the flange 207 and portions of the device body 201 may be bonded to the interior surface 107 of the neck 103. Bonding may include but is not limited to: welding, melting, heat staking, adhesively sealing, and/or a combination thereof.

### Additional Embodiments

The present disclosure is also directed to the following exemplary embodiments, which can be practiced in any combination thereof.

Embodiment 1: A flame mitigation device comprising: a rigid body comprising a side wall having a first perforation of a first size and a second perforation of a second size, wherein the rigid body is hollow, wherein the first size is greater than the second size, wherein the first perforation and the second perforation provide fluid communication through the side wall, and wherein the flame mitigation device is configured to absorb enough heat to drop a burning air/fuel mixture below its auto-ignition temperature at a flame speed between 4 and 6 meters per second.

Embodiment 2: The flame mitigation device of embodiment 1, wherein the first perforation defines a first hole in the side wall, and wherein the second perforation defines a second hole in the side wall, wherein an area of the first hole is greater than an area of the second hole.

Embodiment 3: The flame mitigation device of any of embodiment 1 or 2, further comprising a flange that defines a hole at a first end of the rigid body, and wherein the side wall extends from the flange to a second end of the rigid body along a length of the rigid body.

Embodiment 4: The flame mitigation device of any of embodiments 1-3, wherein the first perforation is from a plurality of first perforations having the first size, and wherein the second perforation is from a plurality of second perforations having the second size.

Embodiment 5: The flame mitigation device of embodiment 4, wherein the plurality of first perforations are comprised within a first region of the rigid body that extends along a circumference of the rigid body and first portion of a length of the rigid body, and wherein the plurality of second perforations are comprised within a second region of the rigid body that extends along the circumference of the rigid body and a second portion of the length.

Embodiment 6: The flame mitigation device of embodiment 4, wherein the plurality of first perforations and the plurality of second perforations are positioned in an alternating pattern along a length of the rigid body.

Embodiment 7: The flame mitigation device of any of embodiments 1-6, wherein the first perforation and the second perforation have substantially the same shape.

Embodiment 8: The flame mitigation device of any of claims 1-7, wherein the first perforation has a different shape than the second perforation.

Embodiment 9: A flame mitigation device, comprising: a rigid body configured to be seated within a nozzle of a fuel container; a first perforation that defines a first hole extending through a side wall of the rigid body; and a second perforation that defines a second hole extending through the side wall, wherein the first hole has a first cross-area that is greater than a second cross-area of the second hole.

Embodiment 10: The flame mitigation device of embodiment 9, further comprising a flange that defines a third hole positioned at an end of the rigid body, wherein the flange has an outer diameter greater than an outer diameter of the rigid body, and wherein the flange is configured to engage an inside surface of the nozzle.

Embodiment 11: The flame mitigation device of embodiment 9 or 10, wherein the side wall extends from the flange to a second end of the rigid body along a length of the rigid body.

Embodiment 12: The flame mitigation device of an of embodiment 10 or 11, wherein the first perforation is of a plurality of first perforations of the side wall, wherein the second perforation is of a plurality of second perforations of the side wall, and wherein the plurality of first perforations and the plurality of second perforations are positioned adjacent to each other and in an alternating pattern on the side wall.

Embodiment 13: The flame mitigation device of embodiment 10 or 11, wherein the first perforation and the second perforation are of a plurality of perforations of the side wall, and wherein a size of the plurality of perforations decreases along the length of the rigid body.

Embodiment 14: The flame mitigation device of any of embodiments 9-13, wherein the size of the plurality of perforations increases in proximity to the second end of the rigid body

Embodiment 15: A flame mitigation device, comprising: a hollow rigid body comprising an opening and a side wall, wherein the opening is positioned at a first end of the hollow rigid body, wherein the side wall extends from the opening to a second end of the hollow rigid body; a first perforation in the side wall; and a second perforation in the side wall, wherein the first perforation has a size that is greater than the second perforation.

Embodiment 16: The flame mitigation device of embodiment 15, wherein the first perforation and the second perforation extend through the side wall in a direction that is perpendicular to a longitudinal length of the hollow rigid body.

Embodiment 17: The flame mitigation device of embodiment 15 or 16, wherein the first perforation has a circular shape, and wherein the second perforation has a polygonal shape.

Embodiment 18: The flame mitigation device of any of embodiments 15-17, wherein the first perforation is of a plurality of first perforations, wherein the second perforation is of a plurality of second perforations.

Embodiment 19: The flame mitigation device of any of embodiments 15-18, wherein the plurality of first perforations and the plurality of second perforations are arranged in an alternating pattern.

Embodiment 20: The flame mitigation device of any of embodiments 15-18, wherein the plurality of first perforations are positioned in a first region of the side wall, wherein the plurality of second perforations are positioned in a second region of the side wall, and wherein the second region is closer to the opening than the first region.

The singular forms “a,” “an,” and “the” include plural referents unless the context clearly dictates otherwise.

Numerical values in the specification and claims of this application should be understood to include numerical values which are the same when reduced to the same number of significant figures and numerical values which differ from the stated value by less than the experimental error of conventional measurement technique of the type described in the present application to determine the value.

All ranges disclosed herein are inclusive of the recited endpoint and independently combinable (for example, the range of “from 2 grams to 10 grams” is inclusive of the endpoints, 2 grams and 10 grams, and all the intermediate values).

As used herein, the terms “generally” and “substantially” are intended to encompass structural or numeral modification which do not significantly affect the purpose of the element or number modified by such term.

The terms “about” and “approximately” can be used to include any numerical value that can vary without changing the basic function of that value. When used with a range, “about” and “approximately” also disclose the range defined by the absolute values of the two endpoints, e.g. “about 2 to about 4” also discloses the range “from 2 to 4.” Generally, the terms “about” and “approximately” may refer to plus or minus 10% of the indicated number.

In this document, relational terms such as first and second, top and bottom, greater than and less than, and the like may be used solely to distinguish one entity or action from another entity or action without necessarily requiring or implying any actual such relationship or order between such entities or actions.

To aid the Patent Office and any readers of this application and any resulting patent in interpreting the claims appended hereto, applicants do not intend any of the appended claims or claim elements to invoke 35 U.S.C. 112(f) unless the words “means for” or “step for” are explicitly used in the particular claim.

What is claimed is:

1. A flame mitigation device comprising:
a rigid body comprising a side wall having a first perforation of a first size and a second perforation of a second size, wherein the rigid body is hollow, wherein the first size is greater than the second size, wherein the first perforation and the second perforation provide fluid communication through the side wall, and wherein the flame mitigation device is configured to absorb enough heat to drop a burning air/fuel mixture below its auto-ignition temperature at a flame speed between 4 and 6 meters per second.

2. The flame mitigation device of claim 1, wherein the first perforation defines a first hole in the side wall, and wherein the second perforation defines a second hole in the side wall, wherein an area of the first hole is greater than an area of the second hole.

3. The flame mitigation device of claim 1, further comprising a flange that defines a hole at a first end of the rigid body, and wherein the side wall extends from the flange to a second end of the rigid body along a length of the rigid body.

4. The flame mitigation device of claim 1, wherein the first perforation is from a plurality of first perforations having the first size, and wherein the second perforation is from a plurality of second perforations having the second size.

5. The flame mitigation device of claim 4, wherein the plurality of first perforations are comprised within a first region of the rigid body that extends along a circumference of the rigid body and first portion of a length of the rigid body, and wherein the plurality of second perforations are comprised within a second region of the rigid body that extends along the circumference of the rigid body and a second portion of the length.

6. The flame mitigation device of claim 4, wherein the plurality of first perforations and the plurality of second perforations are positioned in an alternating pattern along a length of the rigid body.

7. The flame mitigation device of claim 1, wherein the first perforation and the second perforation have substantially the same shape.

8. The flame mitigation device of claim 1, wherein the first perforation has a different shape than the second perforation.

9. A flame mitigation device, comprising:
a rigid body configured to be seated within a nozzle of a fuel container;
a first perforation that defines a first hole extending through a side wall of the rigid body; and
a second perforation that defines a second hole extending through the side wall, wherein the first hole has a first cross-area that is greater than a second cross-area of the second hole.

10. The flame mitigation device of claim 9, further comprising a flange that defines a third hole positioned at an end of the rigid body, wherein the flange has an outer diameter greater than an outer diameter of the rigid body, and wherein the flange is configured to engage an inside surface of the nozzle.

11. The flame mitigation device of claim 10, wherein the side wall extends from the flange to a second end of the rigid body along a length of the rigid body.

12. The flame mitigation device of claim 11, wherein the first perforation is of a plurality of first perforations of the side wall, wherein the second perforation is of a plurality of second perforations of the side wall, and wherein the plurality of first perforations and the plurality of second perforations are positioned adjacent to each other and in an alternating pattern on the side wall.

13. The flame mitigation device of claim 11, wherein the first perforation and the second perforation are of a plurality of perforations of the side wall, and wherein a size of the plurality of perforations decreases along the length of the rigid body.

14. The flame mitigation device of claim 13, wherein the size of the plurality of perforations increases in proximity to the second end of the rigid body.

15. A flame mitigation device, comprising:
a hollow rigid body comprising an opening and a side wall, wherein the opening is positioned at a first end of the hollow rigid body, wherein the side wall extends from the opening to a second end of the hollow rigid body;
a first perforation in the side wall; and
a second perforation in the side wall, wherein the first perforation has a size that is greater than the second perforation.

16. The flame mitigation device of claim 15, wherein the first perforation and the second perforation extend through the side wall in a direction that is perpendicular to a longitudinal length of the hollow rigid body.

17. The flame mitigation device of claim 15, wherein the first perforation has a circular shape, and wherein the second perforation has a polygonal shape.

18. The flame mitigation device of claim 15, wherein the first perforation is of a plurality of first perforations, wherein the second perforation is of a plurality of second perforations.

19. The flame mitigation device of claim 18, wherein the plurality of first perforations and the plurality of second perforations are arranged in an alternating pattern.

20. The flame mitigation device of claim 18, wherein the plurality of first perforations are positioned in a first region of the side wall, wherein the plurality of second perforations are positioned in a second region of the side wall, and wherein the second region is closer to the opening than the first region.
